(19) United States
(12) Patent Application Publication
(10) Pub. No.: US 2006/0016083 A1
(43) Pub. Date: Jan. 26, 2006

(54) Level laser indicator

(75) Inventor: Jason Huang, Taipei (TW)

Correspondence Address: DENNISON, SCHULTZ, DOUGHERTY & MACDONALD, 1727 KING STREET, SUITE 105, ALEXANDRIA, VA, 22314, US

(73) Assignee: INDEX MEASURING TAPE CO., LTD.

(21) Appl. No.: 10/896,976

(22) Filed: Jul. 23, 2004

(51) Int. Cl. G01C 15/00

(52) U.S. Cl. 33/286

(57) ABSTRACT

A level laser indicator comprising a housing, a laser-indicating means and a bubble leveler; wherein one position of the housing is equipped with a laser-indicating means that can rotate freely, which makes the emitting laser light closing to the housing and the measuring surface as the visible light by a refractive lens installed in the front of it; the other position of the housing is equipped with a bubble leveler, which provides a set of holding arms. In addition, there are two nails passes through a base and a magnet is installed on it, so that the whole is conveniently fixed to the wall or the metal surface on a datum plane of measure. Furthermore, two sides of the housing are installed with several vertical grooves/marks, and the angle scale is drawn around said laser-indicating means to conveniently provide with precise measurement of plane.

### BACKGROUND OF THE INVENTION

1. Field of the Invention

This invention relates generally to a level laser indicator and particularly to that the emitted visible light is a laser light close to the housing and the measuring surface emitted by a laser-indicating means, which cooperates with the angle scale, nail, magnet and leveler installed in the housing to conveniently provide with the precise measurement of plane.

2. Description of the Prior Art

It is known that in the fields of carpentry, upholstery, architecture and measurement, all need a datum point and a datum plane to be marked precisely during construction. For the conventional gauge, for example, protractor, plummet, ink marker, range finder and so on, there still exists many troubles and inconvenience in practice. Owing to the conventional gauge with poor precision, many faults may occur easily during construction; because a protractor can't obtain a datum line precisely in measuring angles, an error may be unavoidable during measuring. A plummet may waver and swing easily when hanging. Two persons must stand on two sides of an ink line to pull and flip for a datum line when an ink marker is used to draw a line, which is very inconvenient during the operation. Although a range finder is provided with great precision, its price is expensive considerably.

### SUMMARY OF THE INVENTION

Accordingly, the present invention has been made to solve the above-mentioned problems occurring in the prior alt, and an object of the present invention is to provide a level laser indicator that the laser light emitted by a laser-indicating means stays close to the enclosure and the measuring surface and cooperating with the angle scale, nail, magnet and leveler installed on the housing, the precise measurement of plane is then obtained.

According to the level laser indicator of the present invention, the north direction can be obtained rapidly by using a bubble leveler. In corporation of a laser-indicating means and the visible light emitted by it, any angle line based on a datum point may be obtained rapidly; this is another object of the present invention.

According to the level laser indicator in this invention, one set of nails and a magnet installed on the housing may be fixed rapidly and steadily on a datum plane for precise measurement and for drawing a line, this is also another object of the present invention.

The above objects and other advantages of the present invention will become more apparent by describing in detail the preferred embodiment of the present invention with reference to the attached drawings.

### BRIEF DESCRIPTION OF THE DRAWINGS

FIG. 1 is a three-dimensional assembly diagram of the present invention.

FIG. 2 is a three-dimensional disassembly diagram of the present invention.

FIG. 3 is a diagram showing the preferred embodiment of the present invention in practicing.

FIG. 4 is a cross-sectional view of the example of the nail used in the present invention.

FIG. 5 is a plane diagram of the present invention.

FIG. 6 is a diagram showing the nail is pressed into the wall.

FIG. 7 is a diagram showing the present invention is being adjusted.

FIG. 8 is a diagram showing another practicing example of the present invention.

FIG. 9 is a diagram showing a further practicing example of the present invention.

### DETAILED DESCRIPTION OF THE PREFERRED EMBODIMENTS

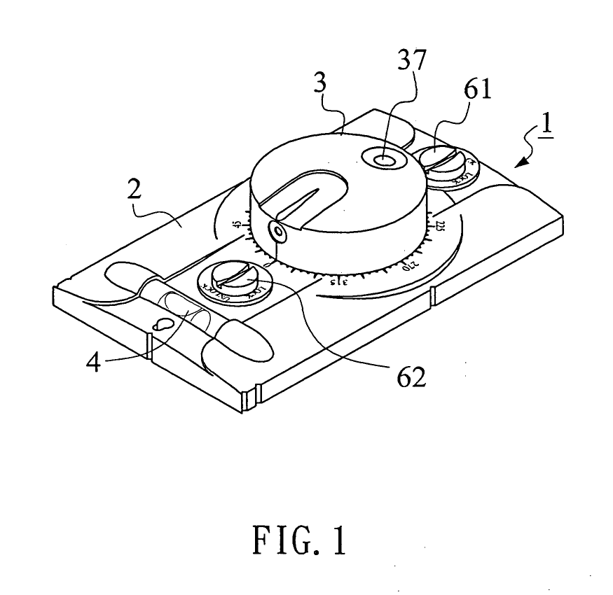

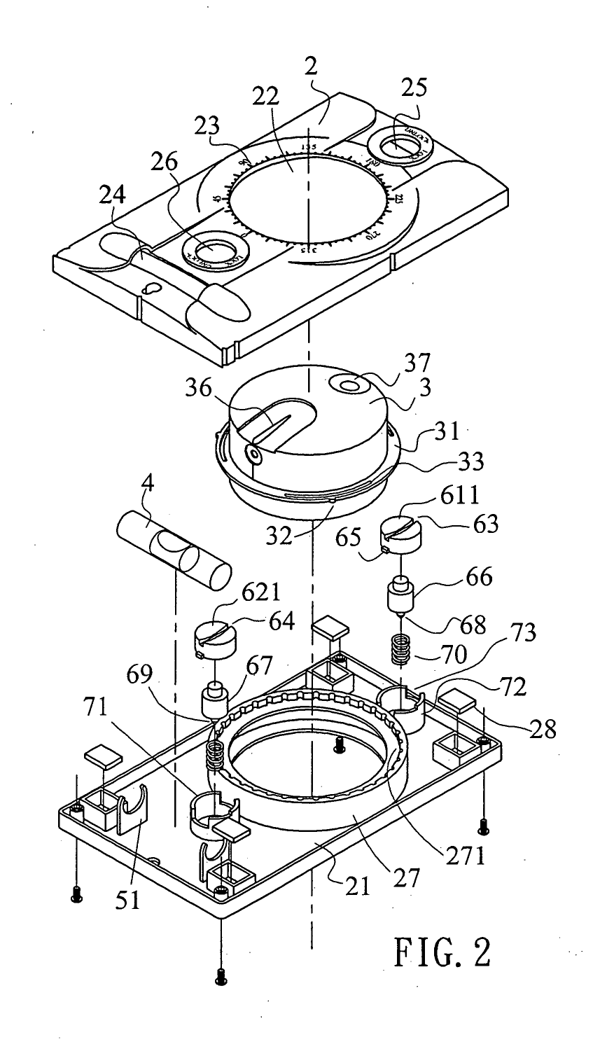

Referring to FIG. 1 and FIG. 2, the level laser indicator 1 of present invention comprises a housing 2, a laser-indicating means 3 and a bubble leveler 4; the housing 2 can be a rectangle box and its bottom may be installed with a bottom cover 21 to form a sealed box. The surface may be formed an insert 22 to install a laser-indicating means 3. The periphery of said insert 22 may be formed with an angle scale 23 in 360° along the circumference, and the angle scale 23 may be marked with an interval of 45°; one side of the housing may be provided with a bar window hole 24 for a bubble leveler 4 to be installed in. The position of bubble in a bubble leveler can be seen by a window hole 24; the bottom of said bubble leveler 4 may be fixed by one set of holding arms 51.

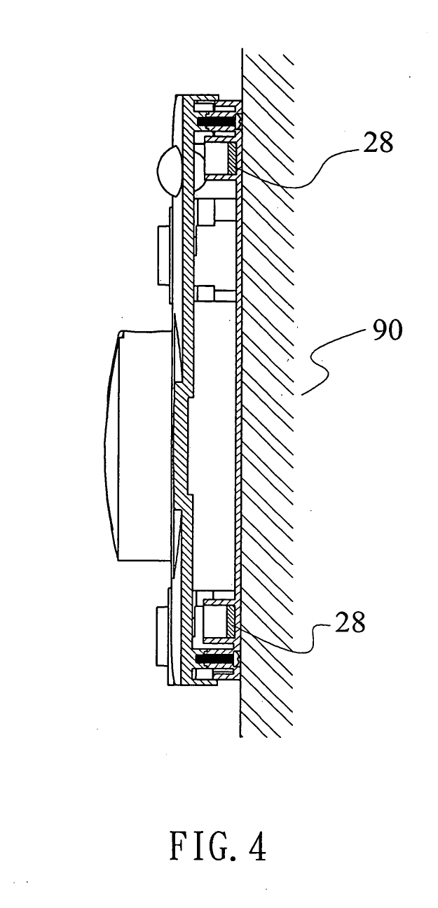

On the surface of said housing 2, there are a pair of insert 22 provided at two opposite positions to install two assembly holes 25 and 26 for two nails 61 and 62. The top of said nails 61 and 62 are formed with caps 611, 621 to provide users for pressing by a thumb. The center of caps 611, 621 are installed with vertical notches 63 and 64 for the safe effect as well as an extruded tenons 65 on the bottom of vertical notch, controlling to press when vertical notches 63 and 64 move to the front (referring to FIG. 4). The bottom of notches may be installed with nail body 68 and 69 that prolongs down to the finite length with an awl shape on the tip. The nail body 68 and 69 may be penetrated through two central holes on the bottom cover 21, cooperating one set of springs 70 and two arc walls 71 and 72 surrounding said springs 70 respectively. On the walls of said arc walls 71 and 72, a partial breach 73 is formed, such that when said extruded tenons 65 face the breach 73, the caps 611, 621 will be pressed downward, and personnel injury owing to the careless exposure of nails 68, 69 would be avoided.

There is also an arc furrow 27 provided at the upper end of the bottom cover 21, on the inner edge of said arc furrow, there is an arc teeth 271, so as to provide the laser-indicating means 3 to be mounted in with the extruded arc plate 31 formed on it peripheral edge. Also, by using the extruded fastener 32 formed at the edge of arc plate 31 and the elastic groove 33 formed at the inner edge of said extruded fastener 32, after the laser-indicating means 3 is mounted into said arc furrow 27, the provision of fastener 32 will occur the sound of “DA DA” when the laser-indicating means 3 is rotated. And, by the provision of elastic groove 33, the extruded fastener would keep elastic property and then its life will be extended. In addition, there are several magnets 28 at the proper locations of the surface of the bottom cover 21, and then the whole body would be attracted to the metal plate 90.

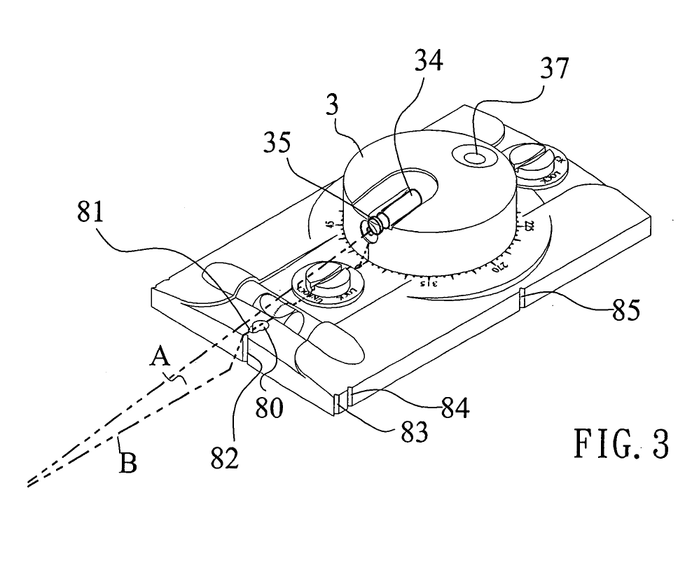

Referring to FIG. 3, a laser-indicating means 3 includes a laser-indicating module 34. The front side of a laser-indicating module 34 is installed with a refractive lens 35. Via the installation of a refractive lens 35, the laser light emitted by a laser-indicating module 34 passes through the refractive lens 35 to form the visible light face A, and then along the surface of the housing, a visible indicating light B is formed. The direction and angle of the laser light can be seen easily when a laser-indicating means 3 rotates to overlap the laser light A with a scale line of angle scale 23.

The top side of a laser-indicating module 34 is installed an indicating arrow 36 to help user see the direction of a laser-indicating apparatus via the tip of an indicating arrow 36. A switch 37 of a laser-indicating means 3 is installed on the topside.

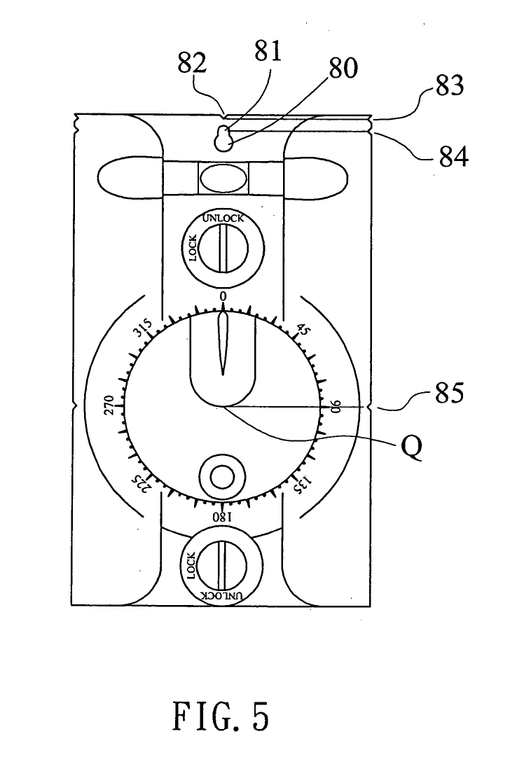

In addition, as shown in FIG. 5, the surface on the top of the housing 2 is formed with a via hole 80, at the front end of the via hole 80, there is a slot 81 having a diameter corresponding to the diameter of the nail. At the front end of the housing 2 corresponding to the vertical line of the slot 81, a top end narrow groove/mark 82 is formed. There are also three grooves/marks provided at the side wall of the housing 2, wherein the first groove/mark 83 in located in the same level with the top end narrow groove/mark 82, the second groove/mark 84 is located at the same level with the center point of said slot 81, and the third groove/mark 85 is located in the same level with the center point of laser-indicating means 3.

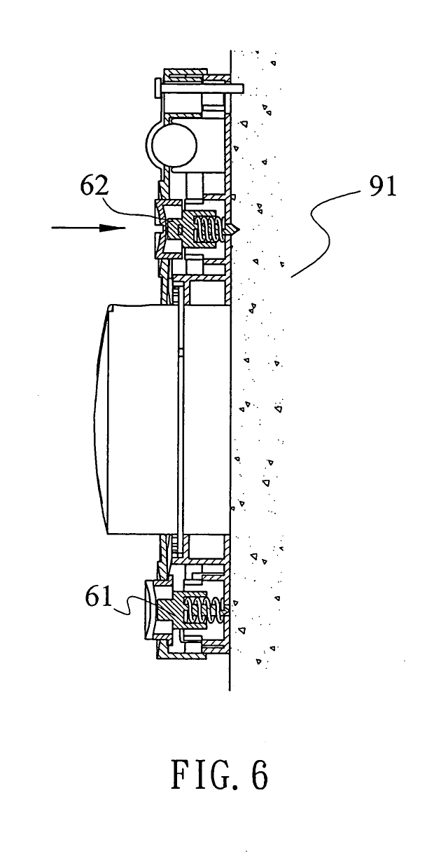

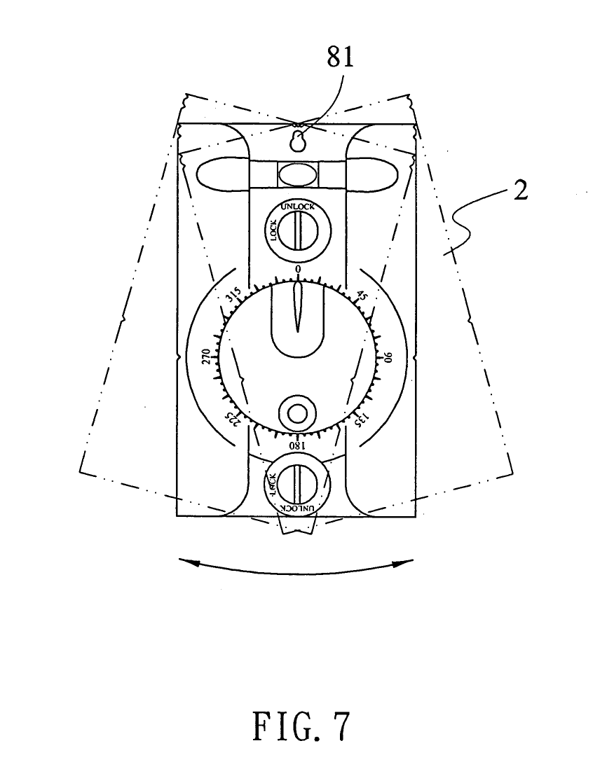

In using the present invention, as shown in FIG. 6, by pressing the nail caps 611, 621 of the nails 61, 62 into the measuring surface, the whole body can be attached at the measuring surface to proceed the light indicating. And, by using the breach 73 formed on the arc wall 71 and 72, together with the provision of tenon 65, personal injuries owing to the careless exposure of nails 68, 69 would be avoided. Moreover, as shown if FIG. 7, because there are sleeves 66, 67 provided at the upper end of the nails 68, 69. And the sleeves are separated from the caps 611, 621, when the nail body of the upper one is pressed into the wall, the housing 2 can be waved until the bubble of bubble leveler 4 is located at the center. Then, after the housing 2 is located at the vertical direction, the lower nail is then pressed into the wall 91 to fix the position of present invention. Such that when the body is waved right and left, the upper nail can maintain the housing 2 firmly on the wall.

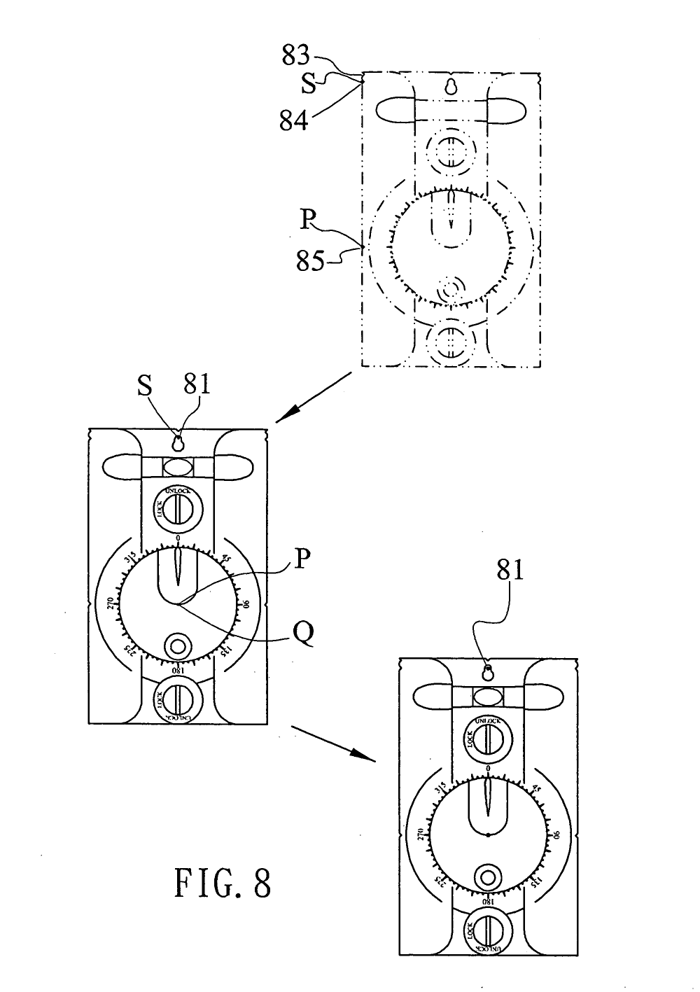

As shown in FIG. 8, because the distance between said third groove/mark 85 and said second groove/mark 84 equals the distance between the central point Q of laser-indicating means and the central point of slot 81. In using the present invention, when the horizontal line, the vertical line and the lines of angles with a point P as its central point is to be drawn. It can be done as shown in FIG. 8, overlapping the third groove/mark 85 with the measuring point P, the side of the housing 2 is used as a rule, the bubble of the bubble leveler 4 is at the center, then drawing a second point S at the position of the second groove/mark 84. After the housing 2 is removed, pressing a hanging nail at the second point S, and hanging the housing onto said hanging nail, the rotation center of laser-indicating means overlapping to the measuring point P is obtained. At this time, rotate laser-indicating means 3, the laser light of visible light shown on the housing and measuring surface is the light drawn by using the point P as a center point. Via the processes shown above, any angular live with the point P as the central point can be obtained.

Or, overlapping the third sleeve/mark 85 with the measuring point P, using the side of the housing 2 as a rule, after the bubble of the bubble leveler 4 is adjusted to be at the center position, then drawing a second point S at the position of the first groove/mark 83. After the housing 2 is removed, overlapping the top end narrow groove/mark 82 with the second point S, adjusting the bubble of the bubble leveler 4 to be at the central position, pressing the nail, then the rotation center Q of laser indication means overlapping to the measuring point P is obtained.

For a level laser indicator in this invention, the laser light emitted by a laser-indicating means 3 can be the visible light drawn along the surface of a housing; the direction and angle is overlapped with an angle scale 23 via the laser light, providing a user with properties to be utilized conveniently. When accomplishing, the whole can rapidly fix on a datum plane of measurement like wall via the installation of nails 61 and 62. In addition, a magnet 28 installed inside a bottom cover may be provided to magnetize and fix the surface of metal material and measure a drawing line and indication.

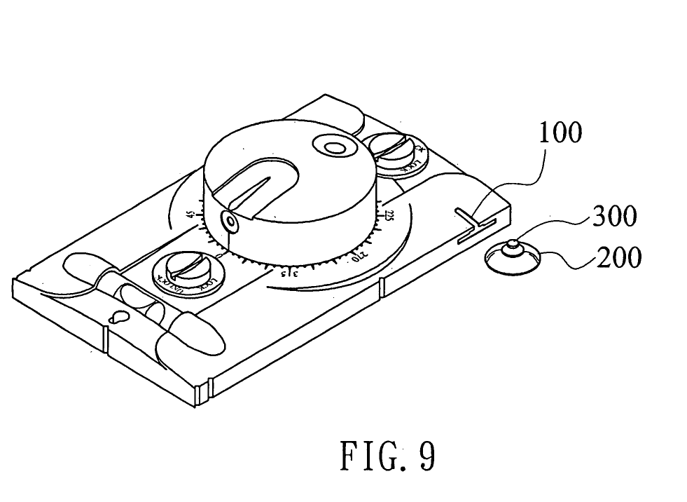

In addition, the present invention can be modified as shown in FIG. 9, forming at least one furrow 100 on the side wall(s) of the housing 2 for holding fixing element(s) 200. The preferred embodiment of the fixing element 200 is a plastic vacuum sucker 200, the upper end of the vacuum sucker 200 is formed as a head structure 300, such that when it is necessary for people to perform a measurement of smooth plane as glass, the plastic vacuum sucker 200 can be taken out to attach onto a smooth plane, and the put the slot 81 formed on the housing 2 onto the head structure 300 of the plastic vacuum sucker 200. Then the housing 2 can be quickly positioned for measurement.

In view of the foregoing, it is known for a level laser indicator of the present invention, the laser light emitted by a laser-indicating means 3 may be formed the visible light drawn along the surface of an enclosure. Cooperating with a nail, bubble leveler and vertical trough installed not only may rapidly swing to position, but also may be easily obtained the direction and angle of a horizontal plane.

Although the above-mentioned embodiments of the present invention has been described for illustrative purposes, those skilled in the art will appreciate that various modifications, additions and substitutions are possible, without departing from the scope and spirit thereof as disclosed in the accompanying claims.

What is claimed is:

1. A level laser indicator comprising:
a housing, a laser-indicating means and a bubble leveler; wherein, a bottom cover is formed on the bottom of said housing, a holding arm is formed on the top of said bottom cover to hold a bubble leveler; an insert is also formed to assemble said laser-indicating means, and an angle scale is formed around the surface of said insert;
a top end of said laser-indicating means, installed between said enclosure and bottom cover, stretches out of said housing for the use of rotation; said laser-indicating means includes laser-indicating module and refractive lens, so that the laser light emitted by said laser-indicating module passes said refractive lens to form the visible light drawn along the surface of said housing and measurement; the direction and angle of the laser light can be seen easily when said angle scale is installed.

2. The level laser indicator as claimed in claim 1, there are two nails provided at the surface of the housing, the top of said nails is informed in cap shape to provide users for pressing by a thumb, the bottom of the nail body is provided with a sleeve, the bottom end of said sleeve extends a nail body penetrating through two central holes of said stud on the bottom cover, so that said nails can be pressed to fix on the surface of the measurement (for example wall or substrate), and the housing can be freely waved right and left until it is adjusted to the central positions.

3. The level laser indicator as claimed in claim 2, wherein the cap of nail provides with a vertical notch and a tenon, so that said nails can be pressed when rotating to certain angle.

4. The level laser indicator as claimed in claim 1, wherein there are several separate narrow grooves/marks formed on the side of the housing.

5. The level laser indicator as claimed in claim 1, wherein a hanging hole is formed at the upper end of the housing, the top end of the hanging hole is a slot, and a top end narrow groove/mark is also formed.

6. The level laser indicator as claimed in claim 4, wherein the grooves/marks formed at the said of housing includes a first groove/mark located at the same level with the top end narrow groove/mark, a second groove/mark located at the same level with the central point of said groove/mark, and the third groove/mark located in the same level with the central point of laser-indicating means.

7. The level laser indicator as claimed in claim 5, wherein the grooves/marks formed at the said of housing includes a first groove/mark located at the same level with the tip end narrow groove/mark, a second groove/mark located at the same level with the central point of said groove/mark, and the third groove/mark located in the same level with the central point of laser-indicating means.

8. The level laser indicator as claimed in claim 1, there are magnet(s) at the surface of the bottom cover of the housing, such that the whole body can be attracted firmly onto the surface of metal materials, so as to properly adjust its vertical or horizontal positions.

9. The level laser indicator as claimed in claim 1, wherein at least one furrow is formed on the wall of the housing and a fixing element is put into the furrow.

10. The level laser indicator as claimed in claim 9, wherein the fixing element is a plastic vacuum sucker with a head structure.
